(19) United States
(12) Patent Application Publication
(10) Pub. No.: US 2005/0026798 A1
(43) Pub. Date: Feb. 3, 2005

(54) Disposal cleaner

(76) Inventor: Bruce Hollander, Boca Raton, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 10/900,866

(22) Filed: Jul. 27, 2004

Related U.S. Application Data
(60) Provisional application No. 60/491,040, filed on Jul. 30, 2003.

(51) Int. Cl. B08B 9/00

(52) U.S. Cl. 510/194; 134/22.1; 134/26

(57) ABSTRACT

A garbage disposal cleaning composition is disclosed, which includes a surfactant and a biodegradable natural particulate friction component. The biodegradable natural particulate friction component includes coffee grounds or ground nutshell such as black walnut shell, pecan shell, apricot shell or English walnut shell. The composition can further include antimicrobial, deodorizing agent, effervescent agent, builder, and fragrance. The garbage disposal cleaning composition can be in the form of tablet, liquid suspension, powder or gel. Also disclosed is the method of enhanced cleaning of a garbage disposal using the garbage disposal cleaning composition.

### REFERENCE TO RELATED APPLICATION

This application claims the benefit under 35 USC 119 (e) of the provisional patent application Ser. No. 60/491,040 filed Jul. 30, 2003, which is herein incorporated by reference in its entirety.

### FIELD OF THE INVENTION

The present invention relates to cleaning compositions for cleaning garbage disposal units. More particularly, the present invention relates to garbage disposal cleaner compositions containing a biodegradable natural particulate friction component for enhancing cleaning efficiency of the blade surface and chamber walls of the disposal units.

### BACKGROUND OF THE INVENTION

In-sink garbage disposal units are employed in homes, restaurants and the like to dispose of unwanted food scraps. As a result, garbage disposal units create sanitary problems such as grease build-up, bacterial build-up, and unpleasant odor.

By design, any materials fed into a disposal unit are pushed by centrifugal force into a series of cutting blades and forced through a screen into a drain line. In order to make an effective cleaning and degreasing product for disposal units, it is necessary to provide a product which maintains a sufficient contact time with the walls of the chamber for grease cutting purposes, and is not easily sucked or drawn into the drain during operation of the disposal unit.

Numerous types of cleaning compositions are known in the art, which utilize various cleaning mechanisms. U.S. Pat. No. 5,464,766 (to Bruno) discloses a multi-enzyme powdered composition containing bacteria for treatment of waste. U.S. Pat. No. 6,016,980 (to Hill) discloses a garbage disposal substance dispensing apparatus comprising a hollow container with multiple apertures and a solid form cleaner packed inside the hollow container. In use, the apparatus is placed into the disposal chamber, wherein the solid form cleaner dissolves when in contact with water, and provides a cleaning function. U.S. Pat. No. 6,397,862 (to DeSenna et al) discloses a non-liquid garbage disposal sanitizer in a tablet form, which includes hypochlorite generator, an effervescent system, binder, lubricant, cellulose, fragrance and surfactant. Although the cleaners provided by these references are in solid form, powder or tablet, the solid cleaners dissolve immediately upon in contact with water. The cleaning depends on enzyme activities, surfactant's functions, foaming and disinfection. No physical friction is utilized for the cleaning process.

U.S. Pat. No. 4,619,710 (to Kuenn et al) discloses a composition for cleaning an in-sink garbage disposal unit containing a surfactant, an alkali carbonate and an acid. Optionally, the composition also incorporates an abrasive for physical cleaning of the disposal unit. Kuenn et al further disclose that suitable abrasives are quartz, pumice, pumicite, silica sand, calcium carbonate, calcium phosphate, zirconium silicate, and preferably, diatomaceous earth, and the abrasive particles are in the range of 1-250 micrometers. These abrasives are sand type, which are not biodegradable and can deposit and accumulate in the drainage pipe and cause clogging of the drainage system. Furthermore, the hardness of these materials can also cause degradation of the disposal blades and decrease life time of the garbage disposal.

It is, therefore, desirable to provide an improved composition for cleaning garbage disposal more effectively, without causing undesirable side effects.

On the other hand, coffee ground is an industrial waste of the instant coffee manufacturers, and household waste of regular coffee consumers. Coffee is an endocarp which, at least after it has been roasted, is hard and tough. In the manufacture of instant coffee, the beans are roasted, ground and processed to remove the soluble solid content. The coffee particles emerge as a hot, moist waste product, which are mainly grounds whose largest dimension may be 2 mm or less. The spent coffee grounds are available as waste materials in substantial quantities. In countries where dumping is not permitted they are often incinerated, usually with the admixture of coal, so that the wastes are generally a liability to the manufacturer of the instant coffee.

Coffee grounds have been used in making composition board in construction and furniture industries in South Africa, as shown in U.S. Pat. No. 4,364,979 (to Button). However, majority of coffee grounds are still industrial and household waste. The situation is similar to various nut shells, which are mainly agriculture and household waste.

Ground black walnut shell is a hard, chemically inert, nontoxic and biodegradable abrasive. It makes up a large percentage of the nut and has a wide range of applications. Black walnut shell abrasive is used to blast clean and polish soft metals, fiberglass, wood, plastics and stone. It is an efficient soft abrasive when used to tumble and polish gun casings, jewelry, ink pens and metal parts, and can also be used to prepare surfaces and equipment for painting. It has been recognized that for industrial uses, ground black walnut shells have various advantages, such as cleaning precision parts without scratching, pitting or changes in dimensions, non-toxic and dust free.

Ground black walnut shells and other ground nut shells, such as pecan shell, apricot shell and English walnut shells, are commercially available. The size of the grounds can be from about 0.05 mm to about 2 mm, which can be sifted into desired size ranges.

Ground nut shells and coffee grounds have a light weight. As wastes of natural products they are biodegradable, and environmental friendly materials. In light of their availability and environmental compatibility of these natural product wastes, it would be desirable to better utilize ground nut shells and coffee grounds. Furthermore, it would be desirable to use natural particulate materials as abrasives for improving garbage disposal cleaning efficiency as described above.

### SUMMARY OF THE INVENTION

In one aspect, the present invention is directed to a garbage disposal cleaning composition. The garbage disposal cleaning composition comprises a surfactant; a biodegradable natural particulate friction component; and a medium. Suitable surfactants include anionic surfactant, cationic surfactant, nonionic surfactant, amphoteric surfactant, and combination thereof. Suitable biodegradable natural particulate friction components include coffee grounds and ground nutshells, such as ground black walnut shell, pecan shell, apricot shell, English walnut shell, and combination thereof.

The garbage disposal cleaning composition can further comprise a medium, an antimicrobial and a deodorant.

In a further aspect, the present invention is directed to a method of cleaning a garbage disposal. The method includes the steps of (a) placing a garbage disposal cleaning composition inside a garbage disposal chamber underneath a baffle, wherein the garbage disposal cleaning composition comprising a surfactant and a biodegradable natural particulate friction component; (b) turning on the garbage disposal with rinsing water for a first period of time sufficient for the particulate friction component of the composition scrubbing the blades, chamber wall and baffle; (c) turning off the garbage disposal for a second period of time sufficient for the composition being contact with the blades, chamber wall and baffle; and (d) turning on the garbage disposal with rinsing water for a third period of time sufficient for the particulate friction component of the composition further scrubbing the blades, chamber wall and baffle, and rinsing out the composition from the garbage disposal.

### DETAILED DESCRIPTION OF THE INVENTION

In one embodiment, the present invention provides a garbage disposal cleaning composition which includes a surfactant, and a biodegradable natural particulate friction component for enhancing cleaning efficiency by providing physical friction on the surface of the blades and the disposal chamber walls.

The surfactant can be anionic, cationic, nonionic or amphoteric surfactants, known in the art, or combination thereof. Preferably, anionic surfactants, such as alkyl sulfate, alkylbenzene sulfonate, alkylarylsulfonate, ethoxylate alkylether sulfate, can be used. The surfactants have strong dispersing property for grease in the disposal chamber. Furthermore, their foaming property is beneficial for maintaining the contact of the cleaning composition with the chamber walls and the disposal baffle.

The biodegradable natural particulate friction component can be ground nutshells, coffee grounds and other suitable natural materials. Suitable ground nutshells include, but are not limited to, ground black walnut shell, pecan shell, apricot shell and English walnut shell. Ground black walnut shell, pecan shell, apricot shell and English walnut shells are commercially available. For the purpose of the present invention the size of the natural particulate friction component can be in a size range from about 10 μm to about 2 mm in diameter.

Using these natural materials has several advantages. They are light weight and will not substantially increase the weight of the cleaner product as it would with silica type of material. As stated previously, coffee ground and ground nut shells are biodegradable; therefore, the particulate waste flushed out with waste water will not be a potential problem for the drainage system and surrounding environment. More importantly, coffee or nut shell grounds can be further ground by the disposal blades when in contact with the blades. Therefore, they are less hazardous, in comparison to sand type particles, to the blades quality, and would not affect the product life of the disposal. Moreover, using ground nut shell and/or coffee grounds recycles the waste materials, therefore, it will be resource and energy saving.

In a further embodiment, the garbage disposal cleaning composition can further comprise one or more antimicrobials to eliminate microorganisms such as bacteria, fungi, germs inside the disposal chamber, therefore, sanitize the disposal unit. Moreover, the garbage disposal cleaning composition can further include a deodorizing agent, which can control odor present in the disposal chamber and prevent release of odor during the cleaning process. The deodorizing agent can be a commonly used deodorant in the household product, or chlorine or bromine releasing chemicals. The garbage disposal cleaning composition can also include an enzyme for enhanced cleaning, which can be one or more those used in the liquid or solid form of detergents.

The garbage disposal cleaning composition further comprises a suitable medium depending on the forms of the composition. Suitable medium includes water, builder, water soluble gel and those materials known in the detergent industry. Optionally, the garbage disposal cleaning composition can further include effervescent agent and fragrance, which are commercially available for the detergent industry.

In one embodiment, the garbage disposal cleaning composition is in a form of liquid suspension. As one example, a household dishwashing detergent, which contains one or more surfactants, is mixed with ground black walnut shell or coffee grounds in a ratio of 85% vs 15% (volume by volume) to form a liquid suspension. The ground black walnut shells can be obtained from commercial available source, such as Hammons Products Company, Stockton, Mo. Coffee grounds can be obtained from instant coffee manufacturers. For an individual use, one can use the coffee grounds left from making coffee in a user's kitchen.

In use, the user mixes the liquid suspension, pours a sufficient quantity of the cleaning composition into the garbage disposal chamber, together with running tap water, then turns on the garbage disposal for a short period of time, such as from about 10 seconds to about a minute. Upon agitation, the detergent foams, which provides a surface contact of the detergent with the chamber walls as well as the baffle. At the same time, the coffee ground particles scrub the blade surface and the chamber walls. It is preferred to turn off the garbage disposal for a short period of time, such as for a few minutes to allow the detergent to interact with the grease and the deposit materials, then turn on the garbage disposal again for another period of time, such as from a minute to a few minutes, together with running tap water. During the incubation, grease and deposit materials are loosen by the detergent. With the second agitation, the coffee ground particles further scrub the grease and other deposit materials away from the blades, chamber walls, as well as the bottom surface of the baffle.

The physical friction provided by the ground nut shells or coffee grounds enhances the cleaning efficiency of the detergent. This action is similar to cleaning a sink or a frying pan using a brush with dish washing detergent, wherein the brush provides the physical friction on the surface. It is common that grease and other deposit materials form thick layers of aggregates. Without physical scrubbing, it is difficult to efficiently clean garbage disposals. However, it is not feasible to use a brush inside the garbage disposal because it is difficult to access the inside, and it is dangerous to touch the blades. With the cleaning composition and the method of use of the present invention, ground nut shells or coffee grounds provide a strong scrubbing action on all surfaces inside the garbage disposal including the corners and the areas underneath the baffle, therefore, it can substantially enhance cleaning function of the detergent.

In a further embodiment, the garbage disposal cleaning composition is in a powder form. In this form, the ground nut shell or coffee ground is mixed with powder form detergent in appropriate proportion. The powder cleaning composition can be packed in bulk or packed into individual pouches for each cleaning use. In use, the user pours the powder cleaning composition into the garbage disposal chamber with running tap water, then cleans the garbage disposal unit in the similar manner of using the liquid composition described above. It is known that the powder detergent tends to aggregate into cake, which makes scooping difficult. However, ground nut shell or coffee grounds have oily surfaces, which render the powder cleaning composition more difficult to cake. In this aspect, the mixture of powder detergent and coffee or nut shell grounds can have an improved storage property.

Furthermore, the garbage disposal cleaning composition can also be in a water soluble gel form.

In another embodiment, the garbage disposal cleaning composition is in a pre-pressed solid form, such as tablets, which contains dry detergent and ground nut shell or coffee grounds, may further contains antimicrobial and deodorant. The tablet can have a diameter from about 1 inch to about 3 inches, and a height from about 0.5 inches to about 2 inches. The tablets can be packed in bulk or packed into individual pouches for each cleaning use. Preferably, the tablet is wrapped with a water soluble wrapping, such as a chemically inert gel, to protect user's hands. The wrapping dissolves rapidly when in contact with water.

In use, the user places a tablet into the garbage disposal chamber, and turns on the garbage disposal with running tap water. The water soluble detergent dissolves and the ground nut shell or coffee grounds suspend in the mixture, similar to the use of the liquid cleaning composition. Furthermore, prior to dissolution of the tablet, the disposal can be turned on. The blades can slice into the surface of the tablet, which creates further physical frictions on the blade surface, and enhances the cleaning efficiency.

As described above, the present invention provides a garbage disposal cleaning composition, in various forms, for enhanced cleaning, degreasing and sanitizing garbage disposal units.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A garbage disposal cleaning composition comprising:
(a) a surfactant; and
(b) a biodegradable natural particulate friction component.

2. The garbage disposal cleaning composition of claim 1, wherein said surfactant is one or more selected from the group consisting of anionic surfactant, cationic surfactant, nonionic surfactant, amphoteric surfactant, and combination thereof.

3. The garbage disposal cleaning composition of claim 1, wherein said surfactant is one or more selected from the group consisting of an alkyl sulfate, alkylbenzene sulfonate, alkylarylsulfonate, ethoxylate alkylether sulfate, and combination thereof.

4. The garbage disposal cleaning composition of claim 1, wherein said biodegradable natural particulate friction component is coffee grounds.

5. The garbage disposal cleaning composition of claim 1, wherein said biodegradable natural particulate friction component is ground nutshell.

6. The garbage disposal cleaning composition of claim 5, wherein said ground nutshell is one or more selected from the group consisting of ground black walnut shell, pecan shell, apricot shell, English walnut shell, and combination thereof.

7. The garbage disposal cleaning composition of claim 1, wherein said biodegradable natural particulate friction component is in a size range from about 10 μm to about 2 mm in diameter.

8. The garbage disposal cleaning composition of claim 1, wherein said composition is in a tablet form.

9. The garbage disposal cleaning composition of claim 1, wherein said composition is in at least one form selected from the group consisting of liquid suspension, powder and gel.

10. A garbage disposal cleaning composition comprising:
(a) a surfactant;
(b) a biodegradable natural particulate friction component;
(c) an antimicrobial;
(d) a deodorizing agent; and
(e) a medium.

11. The garbage disposal cleaning composition of claim 10, wherein said biodegradable natural particulate friction component is coffee grounds.

12. The garbage disposal cleaning composition of claim 10, wherein said biodegradable natural particulate friction component is ground nutshell.

13. The garbage disposal cleaning composition of claim 12, wherein said ground nutshell is one or more selected from the group consisting of ground black walnut shell, pecan shell, apricot shell, English walnut shell, and combination thereof.

14. The garbage disposal cleaning composition of claim 14, wherein said biodegradable natural particulate friction component is in a size range from about 10 μm to about 2 mm in diameter.

15. A method of cleaning a garbage disposal comprising the steps of:
(a) placing a garbage disposal cleaning composition inside a garbage disposal chamber underneath a baffle, wherein said garbage disposal cleaning composition comprising a surfactant and a biodegradable natural particulate friction component;
(b) turning on said garbage disposal with rinsing water for a first period of time sufficient for said particulate friction component of said composition scrubbing blades, a chamber wall and said baffle;
(c) turning off said garbage disposal for a second period of time sufficient for said composition being contact with said blades, chamber wall and baffle; and
(d) turning on said garbage disposal with rinsing water for a third period of time sufficient for said particulate friction component of said composition further scrubbing said blades, chamber wall and baffle, and rinsing out said composition from said garbage disposal.
